(19) United States
(12) Patent Application Publication
(10) Pub. No.: US 2006/0077044 A1
(43) Pub. Date: Apr. 13, 2006

(54) Wireless communications systems, remote communications devices, and wireless communications methods

(76) Inventors: Michael A. Hughes, Pasco, WA (US); Richard M. Pratt, Richland, WA (US)

Correspondence Address: WELLS ST. JOHN P.S., 601 W. FIRST AVENUE, SUITE 1300, SPOKANE, WA, 99201, US

(21) Appl. No.: 10/962,006

(22) Filed: Oct. 8, 2004

(51) Int. Cl. H04Q 5/22

(52) U.S. Cl. 340/10.34; 455/343.2

(57) ABSTRACT

Wireless communications systems, remote communications devices, and wireless communications methods are described. In one aspect, a wireless communications system includes a reader configured to output a plurality of wireless communications signals, a plurality of remote communications devices in communication with the reader and configured to receive the wireless communications signals, and wherein at least one of the remote communications devices comprises communications circuitry configured to receive the wireless communications signals and processing circuitry configured to process the wireless communications signals, wherein the communications circuitry and the processing circuitry are individually configured to operate in a plurality of operational states including a first operational state corresponding to an absence of the wireless communications signals at the at least one remote communications device, a second operational state corresponding to the presence of the wireless communications signals at the at least one remote communications device, and wherein electrical energy is consumed at an increased rate by the remote communications device during the operation in the second operational state compared with the operation in the first operational state.

### TECHNICAL FIELD

This invention relates to wireless communications systems, remote communications devices, and wireless communications methods.

### BACKGROUND

Remote wireless communications may be implemented using radio frequency (RF) technology. Exemplary applications utilizing RF technology include identification applications including, for example, locating, identifying, and tracking of objects. Radio frequency identification device (RFID) systems may be utilized to facilitate identification operations. For example, one device may be arranged to output and receive radio frequency communications and one or more remotely located device may be configured to communicate with the one device using radio frequency communications. The remotely located device(s) may be referred to as tag(s) in one identification implementation, while the other device may be referred to as a reader. Some advantages of radio frequency communications of exemplary radio frequency identification device systems include an ability to communicate without contact or line-of-sight, at relatively fast speeds, and with robust communications channels.

Some remotely located devices may have on-board batteries to provide operational energy to implement communications including receiving and/or transmission capabilities. Some systems may be used in an application wherein monitoring and communication capabilities of a remotely located device may be desired for extended periods of time (e.g., months, years, etc.). Accordingly, in some implementations, it may be desired to reduce electrical consumption of the device to maximize the life of a battery or other power source.

In one arrangement, a duty cycle of a receiver may be reduced for example in time based sampling where a receiver is powered up for short periods on a time schedule to monitor for communications then powered back down until the subsequent sample time. The sampling interval determines the response time of the system so the receiver may have to be powered up several times a second in some embodiments.

At least some aspects of the disclosure provide improved communications systems, devices and methods.

### BRIEF DESCRIPTION OF THE DRAWINGS

Exemplary embodiments of the disclosure are described below with reference to the following accompanying drawings.

FIG. 1 is a functional block diagram of a wireless communications system according to one embodiment.

FIG. 2 is a functional block diagram of a remote communications device according to one embodiment.

FIG. 3 is a schematic representation of exemplary receiver circuitry according to one embodiment.

FIG. 4 is a map illustrating how FIGS. 4A-4B are to be assembled.

FIGS. 4A-4B when assembled are a schematic diagram of exemplary circuitry of a remote communications device according to one embodiment.

FIG. 5 is a map illustrating how FIGS. 5A-5B are to be assembled.

FIGS. 5A-5B when assembled are a schematic diagram of exemplary circuitry of a remote communications device according to another embodiment.

### DETAILED DESCRIPTION

According to one aspect of the disclosure, a wireless communications system comprises a reader configured to output a plurality of wireless communications signals, a plurality of remote communications devices in communication with the reader and configured to receive the wireless communications signals, and wherein at least one of the remote communications devices comprises communications circuitry configured to receive the wireless communications signals and processing circuitry configured to process the wireless communications signals, wherein the communications circuitry and the processing circuitry are individually configured to operate in a plurality of operational states including a first operational state corresponding to an absence of the wireless communications signals at the at least one remote communications device, a second operational state corresponding to the presence of the wireless communications signals at the at least one remote communications device, and wherein electrical energy is consumed at an increased rate by the remote communications device during the operation in the second operational state compared with the operation in the first operational state.

According to another aspect, a remote communications device comprises communications circuitry configured to receive a plurality of wireless communications signals outputted by a reader, processing circuitry coupled with the communications circuitry and configured to process the wireless communications signals and to implement at least one operation of the remote communications device responsive to the processing, wherein the processing circuitry is operable in a plurality of operational states having different rates of consumption of electrical energy including a first operational state in the absence at the remote communications device of the wireless communications signals outputted by the reader and a second operational state corresponding to the presence at the remote communications device of the wireless communications signals outputted by the reader, and wherein the rate of consumption of electrical energy by the communications circuitry is greater in the second operational state compared with the first operational state.

According to yet another aspect of the disclosure, a remote communications device comprises first receiver means for monitoring for the presence of wireless communications signals outputted by a reader, second receiver means for receiving the wireless communications signals outputted by the reader, processing means for processing the wireless communications signals received by the second receiver means, wherein the second receiver means and the processing means comprise means for operating in a plurality of operational states having different rates of electrical energy consumption including a first operational state corresponding to an absence of the wireless communications signals at the remote communications device and a second operational state corresponding to the presence of the wireless communications signals at the remote communications device, wherein the second receiver means and the processing means individually have an increased rate of consumption of electrical energy during operations in the second operational state compared with the first operational state.

According to still another aspect of the disclosure, a wireless communications method comprises receiving a plurality of wireless communications signals outputted by a reader using a remote communications device, controlling processing circuitry of the remote communications device to consume electrical energy at different rates corresponding to respective ones of a presence and an absence of the wireless communications signals at the remote communications device, wherein the processing circuitry is configured to control at least one operation of the remote communications device, first consuming electrical energy using the processing circuitry at a first rate corresponding to the presence of the wireless communications signals at the remote communications device, second consuming electrical energy using the processing circuitry at a second rate corresponding to the absence of the wireless communications signals at the remote communications device, and wherein the first consuming at the first rate comprises consuming the electrical energy at an increased rate compared with the second consuming at the second rate.

According to an additional aspect of the disclosure, a wireless communications method comprises providing a remote communications device, monitoring for the presence of wireless communications signals outputted by a reader using the remote communications device, changing operations of processing circuitry and receiver circuitry of the remote communications device from a reduced electrical energy consumption rate to an increased electrical energy consumption rate responsive to the monitoring detecting the presence of the wireless communications signals from the reader, operably receiving the wireless communications signals using the receiver circuitry operating at the increased electrical energy consumption rate, and returning operations of the receiver circuitry from the increased electrical energy consumption rate to the reduced electrical energy consumption rate after the receiving.

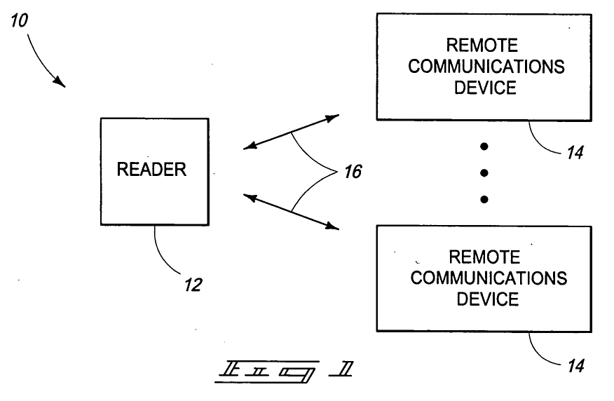

Referring to FIG. 1, an exemplary wireless communications system 10 is depicted. System 10 according to one embodiment includes a first communications device 12 which may be referred to as a reader and one or more second communications device 14 which may be individually referred to as a tag. First and second communications devices 12, 14 are arranged to implement wireless communications 16 in the depicted exemplary embodiment. Possible wireless communications 16 include first (e.g., uplink) wireless communications signals communicated from first communications device 12 and second (e.g., downlink) wireless communications signals communicated from the one or more second communications device 14.

Wireless communications signals include signals which at some point in time are communicated over a wireless medium but may also be communicated over an electrical conductor (e.g., electrical signals within devices 12, 14) at other moments in time. Exemplary wireless communications 16 include electromagnetic energy or signals, such as radio frequency signals. Alternatively, wireless communications 16 may comprise infrared signals, acoustic signals, or any other appropriate signals capable of being wirelessly communicated between devices 12, 14. Wireless communications signals may also be referred to as data signals and include encoded digital information or data to be communicated intermediate devices 12, 14.

System 10 is provided to illustrate exemplary structural aspects and methodical aspects of the present invention. In one exemplary embodiment, system 10 is configured to implement identification operations, such as remote communications devices 14 communicating identifiers which may operate to identify (e.g., uniquely) respective ones of the devices 14 communicating the signals. The identifiers may comprise a desired number of bits (assigned either by hardware and/or software) and be communicated within wireless communications signals comprising data discussed further below in at least one embodiment. In addition, synchronization bits, message integrity data (e.g., CRC bits) and other appropriate header and trailer data may also be communicated in wireless communications 16. Data communicated via wireless communications intermediate devices 12, 14 may be encrypted in some embodiments.

In one possible identification implementation, system 10 is implemented as a radio frequency identification device (RFID) communications system. For example, in such an arrangement, first communications device 12 may be implemented as a reader as shown in FIG. 1 and second or remote communications devices 14 may be implemented as transponders, such as RFID tags, which operate to communicate in response to interrogation signals from device 12. In another embodiment, remote communications devices 14 may comprise beacons. Exemplary devices 14 configured as beacons are typically not arranged to process communications from device 12 but merely formulate and output communications to device 12. In an identification implementation (e.g., RFID), devices 14 may be associated with respective articles (not shown) to implement identification operations of the articles and/or devices 14. More specifically, in one RFID arrangement, devices 14 may communicate signals which contain identification information for the devices 14 and/or associated articles. Other identification operations are possible.

First communications device 12 implemented as a reader may output wireless communications signals for communication to devices 14. The signals outputted from device 12 may comprise commands and/or identifiers to identify one or more of remote communications device(s) 14 intended for reception of the respective signals. Device 12 may also output radio frequency energy, such as a continuous wave signal, which may be backscattered (e.g., reflected) by one or more receiving device(s) 14 for implementing backscatter communications from device(s) 14 to device 12 in one embodiment.

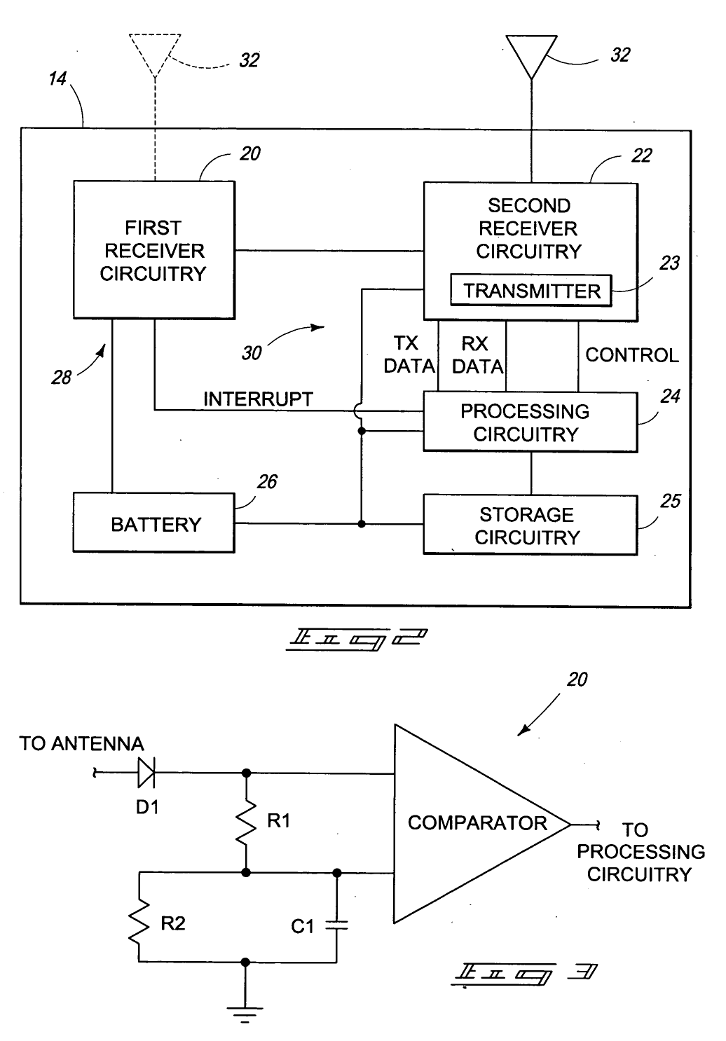

Referring to FIG. 2, an exemplary arrangement of communications device 14 configured to implement RF communications is shown. The exemplary depicted device 14 includes first receiver circuitry 20, second receiver circuitry 22, a transmitter 23, processing circuitry 24, storage circuitry 25, a battery 26, and one or more antenna 32. Other embodiments of communications device 14 including more, less or alternative components are possible.

First receiver circuitry 20 and second receiver circuitry 22 are configured to receive wireless communications 16. In the illustrated exemplary embodiment, receiver circuits 20, 22 are configured to receive wireless communications signals comprising RF energy although other configurations may be used which are configured to receive other types of wireless signals.

In one embodiment, the utilization of plural receiver circuits 20, 22 assists with conservation of electrical energy (e.g., supplied by battery 26). For example, in one embodiment, first receiver circuitry 20 may be configured as a low power receiver configured to consume energy at a reduced rate compared with second receiver circuitry 22 which may be implemented using an active transceiver in one implementation.

More specifically, and in accordance with the presently described embodiment, first receiver circuitry 20 may be referred to as monitoring circuitry 28 configured to monitor for the presence or absence of wireless energy (e.g., RF) at remote communications device 14. In one embodiment, receiver circuitry 20 continuously monitors for the presence of received wireless communications 16 during operations of the device 14. Through utilization of monitoring circuitry 28 in one embodiment, periodic power-ups of second receiver circuitry 22 may be reduced or eliminated which reduces power consumption of device 14.

Second receiver circuitry 22 and/or transmitter 23 may be referred to as communications circuitry 30 and is configured to implement data communications via wireless communications 16 with respect to device 12 or other external device. In one embodiment, second receiver 22′ and transmitter 23 may be implemented as communications circuitry 30 comprising an active transceiver although other arrangements are possible. Exemplary operations of receiver circuits 20, 22 and other circuitry of remote communications device 14 are discussed below to reduce a rate of consumption of electrical energy by device 14 in one implementation.

Processing circuitry 24 is configured to process received communications, and formulate and control the outputting of wireless signals externally of device 14. For example with respect to received communications, the processing circuitry 24 may extract commands and/or data from received communications, process the commands and/or data, and implement an appropriate operation with respect to the device 14. Exemplary operations include formulating communications to be outputted from device 14 (e.g., identification signals identifying device 14), obtaining data requested by device 12, or any other desired actions capable of being controlled by processing circuitry 24.

In one embodiment, processing circuitry 24 may comprise circuitry configured to implement desired programming. For example, the processing circuitry 24 may be implemented as a processor or other structure configured to execute executable instructions including, for example, software and/or firmware instructions. Other exemplary embodiments of processing circuitry include hardware logic, PGA, FPGA, ASIC, state machines, and/or other structures. These examples of processing circuitry are for illustration and other configurations are possible.

According to one exemplary arrangement, communications devices 12, 14 are configured to communicate wireless signals using on/off key (OOK) modulation, such as a biphase space (FM0) or biphase mark (FM1) or Manchester encoding schemes. Other types of modulation or schemes may be utilized to communicate information between devices 12, 14. For example, in one embodiment, the communications protocol of device 14 may be altered via software and/or firmware to allow compatibility with selected or multiple devices 12. Processing circuitry 24 is configured to process received communications including demodulation of the received signals as well as control modulation of wireless communications signals outputted from device 14 in accordance with exemplary embodiments.

Processing circuitry 24 may be configured to control the outputting of wireless communications signals which include identification information of remote communications device 14 and/or an article (not shown) associated with the device 14 as mentioned above in one exemplary arrangement (e.g., RFID). Processing circuitry 24 may be operable to control communication of wireless communications signals from device 14 responsive to processing of one or more wireless communications signals from device 12. For example, processing circuitry 24 may implement transponder communications in one exemplary embodiment. Other configurations may utilize unidirectional or other communications as mentioned above.

Storage circuitry 25 is configured to store electronic data, programming such as executable instructions (e.g., software and/or firmware), and/or other digital information and may include processor-usable media. Processor-usable media includes any article of manufacture which can contain, store, or maintain programming, data and/or digital information for use by or in connection with an instruction execution system including processing circuitry 24 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

In the depicted embodiment, battery 26 is provided and configured to supply operational electrical energy to appropriate components of communications device 14. In other arrangements, additional and/or other sources of electrical energy may be utilized and may comprise one or more of a plurality of different configurations corresponding to the configuration of communications device 14. For example, communications device 14 may be implemented in passive, semi-passive or active configurations in exemplary arrangements and may derive operational electrical energy from received electromagnetic (e.g., radio frequency energy) in some embodiments.

In semi-passive implementations, a suitable energy source may comprise battery 26 utilized to provide electrical energy to circuitry of device 14 while electromagnetic energy received within device 14 may be utilized to generate wireless communications signals outputted from device 14. For example, processing circuitry 24 may implement backscatter modulation of received RF energy to output wireless communications signals in one embodiment.

For active implementations, battery 26 may be arranged to provide operational electrical energy to circuitry of device 14 similar to the described semi-passive implementation. In addition, the battery 26 may also be utilized in the generation of radio frequency energy for communication of wireless signals outputted by device 14 (i.e., active transmit operations).

For passive implementations of device 14, received electromagnetic energy (e.g., radio frequency energy) is utilized to provide operational electrical energy to circuitry of device 14. Further, processing circuitry 24 may backscatter radio frequency energy for communication of wireless signals outputted from device 14. In such an implementation, an exemplary energy source may comprise a power antenna (not shown) and discrete components (e.g., rectifier, voltage doubler, etc.) arranged to convert received electromagnetic energy into usable operational electrical energy.

Exemplary configurations of battery 26 include a coin cell battery, thin flexible one time use battery, or a rechargeable battery which may be recharged by scavenged RF power, light power, changing magnetic fields, acceleration, gravity, mechanical arrangements or other appropriate means.

Different configurations of antenna 32 may be used in different embodiments. One or more antenna 32 may be arranged to communicate (receive and transmit) electromagnetic energy of bi-directional wireless communications signals. In one embodiment, antenna 32 may comprise a single antenna for communication of transmit and receive signals or include a plurality of antennas 32 for dedicated respective transmit and receive operations and/or for receiving signals for dedicated respective receiver circuits 20, 22. For example, if a single antenna 32 is used and coupled with second receiver circuitry 22 as shown in FIG. 2, then first receiver circuitry 20 may receive signals from the antenna 32 coupled with second receiver circuitry 22. In other arrangements, plural antennae 32 (one of which is shown in phantom in FIG. 2) may be used and individually coupled with a respective one of first and second receiver circuits 20, 22. Utilization of plural antennae 32 for respective receive circuits 20, 22 may provide improved sensitivity to received electromagnetic energy compared with configurations utilizing a single antenna 32 inasmuch as receiver circuitry 20 may be isolated from receiver circuitry 22 and the respective antenna 32 associated therewith. Also, separate antennae 32 facilitate usage of different frequencies for communications with the different receiver circuits 20, 22. Other embodiments are possible in other configurations.

As mentioned above, it may be desirable to minimize the rate of consumption of electrical energy by remote communications device 14 in some embodiments. For example, remote communications device(s) 14 may be inaccessible, numerous in number, unavailable or otherwise not conveniently serviceable to replace a battery 26 if utilized. In some implementations, devices 14 may be inactive for extended periods of time awaiting the receipt of wireless communications 16 from device 12. It may be desirable to reduce the consumption of electrical energy by remote communications device 14 during periods of inactivity. According to one embodiment, remote communications device 14 is arranged to operate in a plurality of operational states or modes having different respective rates of electrical energy consumption to reduce power consumption and extend battery life if a battery 26 is provided.

In a more specific illustrative example, remote communications devices 14 are individually arranged to operate in a first operational state corresponding to an absence of wireless communications 16 (e.g., wireless signals outputted by device 12) at the device 14, or in a second operational state corresponding to a presence of wireless communications 16 at the device 14. Remote communications device 14 consumes electrical energy at an increased rate during operation in the second versus the first operational state.

The operation of one or more individual components of device 14 may be altered corresponding to the operational states of the device 14 to change the electrical energy consumption of device 14. In one embodiment, operations of second receiver circuitry 22 and/or processing circuitry 24 may be altered to reduce the rate of consumption of electrical energy by device 14. During periods of inactivity (e.g., an absence of wireless communications 16), receiver circuitry 22 and/or processing circuitry 24 may be partially or completely powered down to reduce energy consumption.

First receiver circuitry 20 operating as monitoring circuitry 28 may monitor for the reception of radio frequency energy which may include wireless communications 16 from device 12 to be processed. In one embodiment, first receiver circuitry 20 may detect the presence of radio frequency energy (e.g., received by a respective antenna 32) and indicate the reception to processing circuitry 24. The exemplary monitoring and analysis operations discussed are with respect to exemplary received radio frequency energy. Other types of energy may be received, monitored and processed in other embodiments.

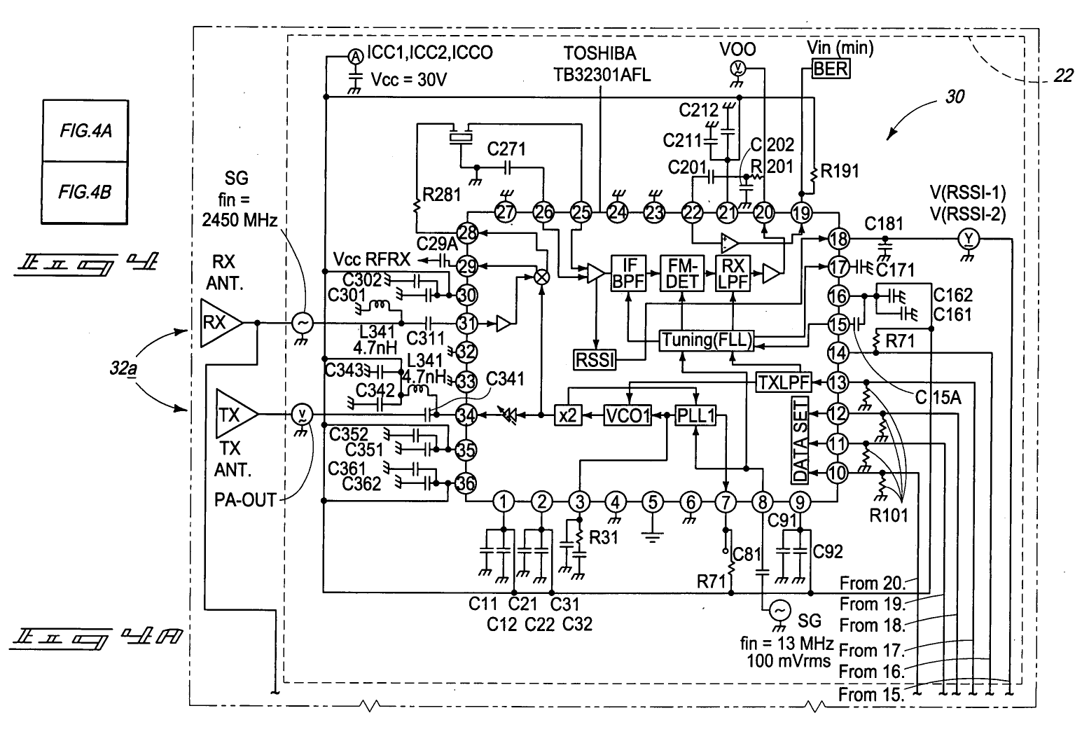

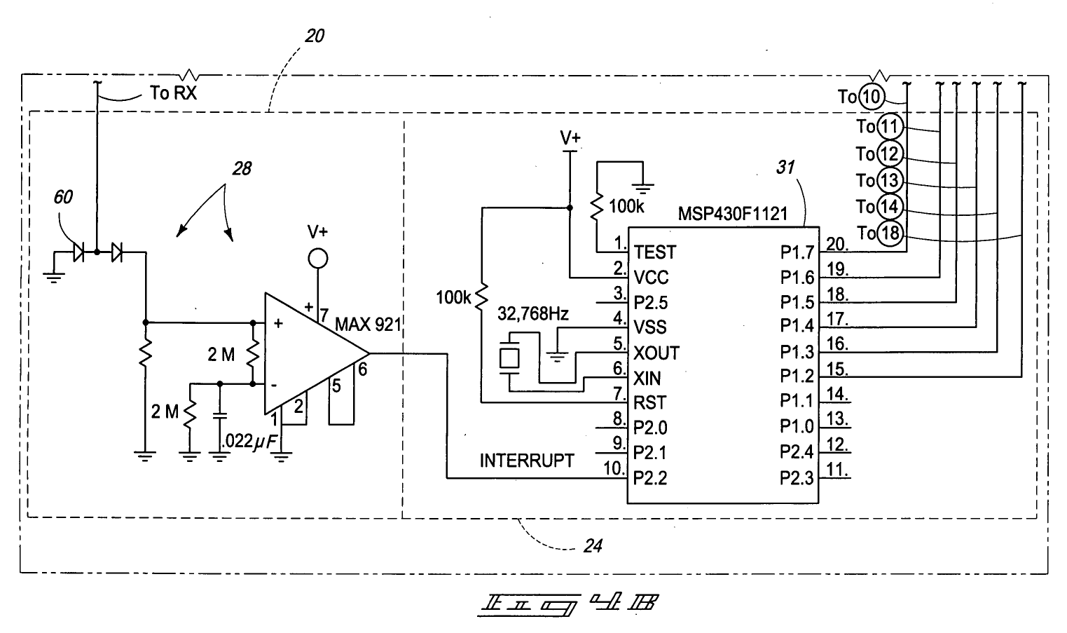

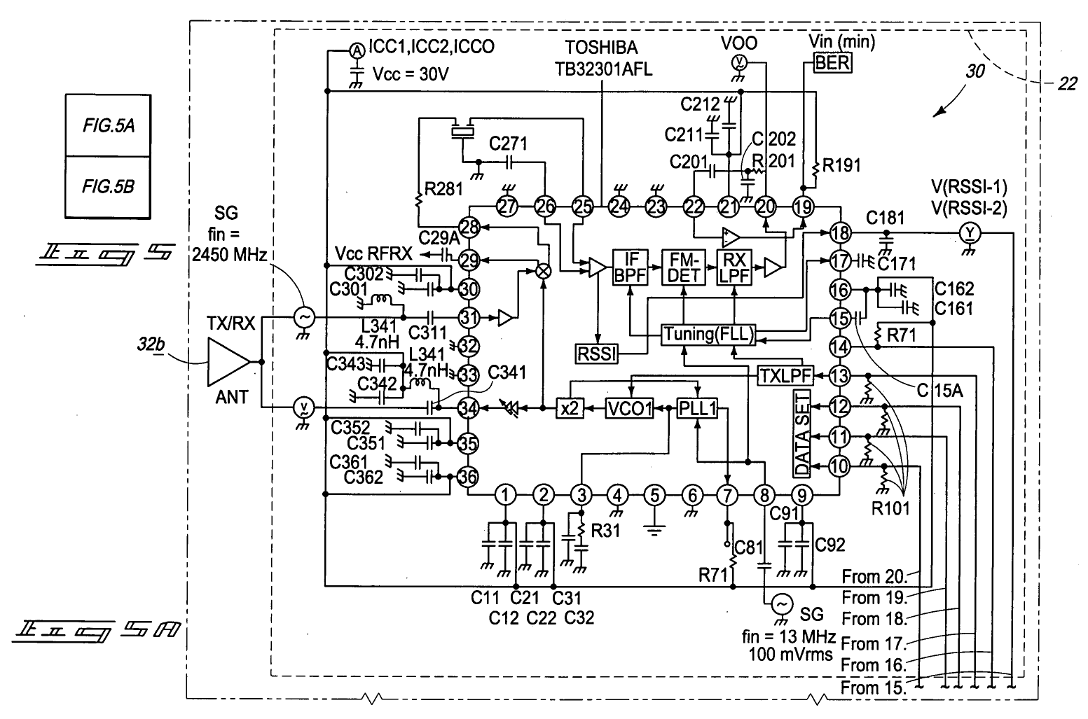

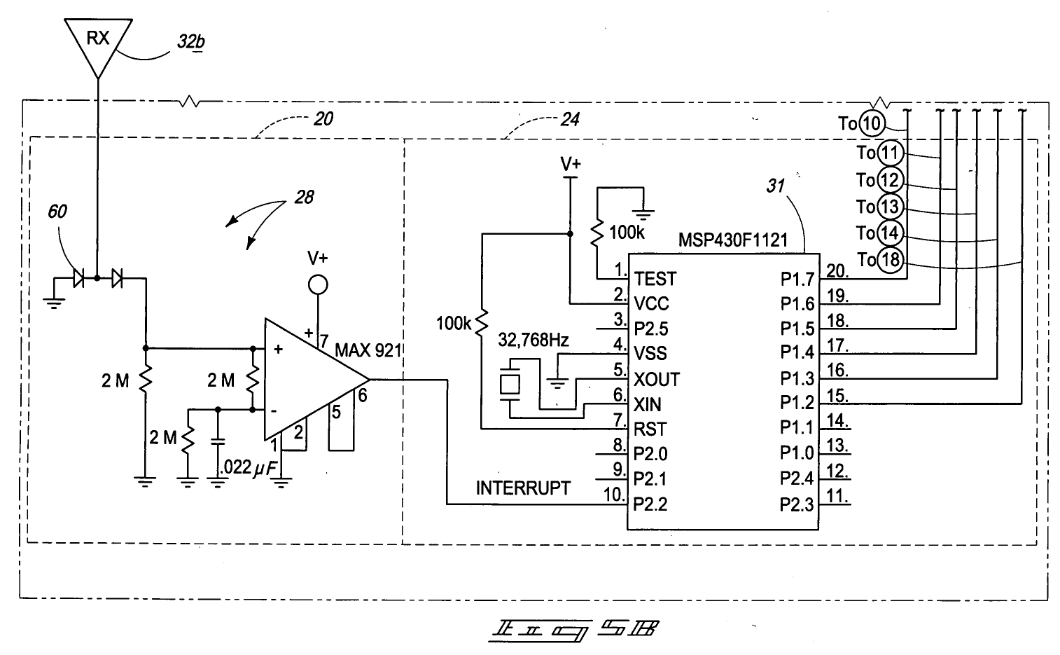

An exemplary embodiment of first receiver circuitry 20 configured as monitoring circuitry 28 is illustrated in FIG. 3 as a diode detector followed by a bit slicer. Receiver circuitry 20 may indicate the presence of radio frequency energy at the remote communications device 14 to processing circuitry 24 by outputting an interrupt signal to an interrupt input of processing circuitry 24. The respective discrete components of the exemplary receiver circuitry 20 may be chosen to pass desired frequencies corresponding to wireless communications 16 outputted by device 12. Additional details regarding exemplary arrangements of receiver circuitry 20 comprising monitoring circuitry 28 are illustrated in FIGS. 4 and 5 below.

Referring again to FIG. 2, upon receipt of an indication of radio frequency energy being present as detected by monitoring circuitry 30, processing circuitry 24 may enter an operational state wherein additional electrically energy is consumed by processing circuitry 24 to verify the presence of wireless communications 16 from device 12 and perform processing of the wireless communications 16 if verified. Also, processing circuitry 24 may power up or control additional components of device 14 (e.g., second receiver circuitry 22) to also enter an operational state wherein additional electrical energy is consumed and/or implement other desired actions responsive to the presence of the radio frequency energy.

In accordance with the described exemplary embodiment and responsive to the presence of the received RF energy, processing circuitry 24 may enter an operational state wherein an increased amount of electrical energy is consumed to permit analysis of the received RF energy. In addition, processing circuitry 24 may control the second receiver circuitry 22 of communications circuitry 30 to enter an operational state wherein an increased amount of electrical energy is consumed to operably receive the radio frequency energy responsive to the detection of the radio frequency energy by first receiver circuitry 20.

Processing circuitry 24 may analyze the radio frequency energy received via second receiver circuitry 22 to determine whether communications 16 from device 12 are present (i.e., verify the presence or absence of wireless communications 16). If the received radio frequency energy is identified as originating from device 12 or other appropriate source, then processing circuitry 24 may control the second receiver circuitry 22 to remain in the operational state of higher electrical energy consumption to continue to operably receive communications. Also, processing circuitry 24 may remain in a higher operational mode to process received communications and formulate communications to be outputted from device 14 if appropriate or implement other operations of device 14.

If the received radio frequency energy is not identified as originating from device 12 or other appropriate source, then processing circuitry 24 may control the second receiver circuitry 22 to return to an operational state of lower electrical energy consumption to await for the reception of future communications and receiver circuitry 22 does not enter a higher state of power consumption. Processing circuitry 24 may also return to the operational state of reduced energy consumption. In one embodiment, second receiver circuitry 22 may not operably receive electromagnetic energy and processing circuitry 24 performs a reduced amount of processing in the respective operational states of reduced energy consumption.

Processing circuitry 24 is configured to perform the below exemplary verification operations to determine whether the received wireless communications signals are intended for the receiving device 14 (e.g., originated from device 12 or other appropriate source) according to one embodiment. Other verification methods are possible.

As mentioned above, wireless communications 16 may be implemented using FM0 encoding in one embodiment. Wireless communications device 12 may output signals for communications to devices 14 having an initial synchronization pattern of a number of cycles individually having a 50% duty cycle in one embodiment. Processing circuitry 24 is configured in one arrangement to measure the period of the cycles during the synchronization pattern to extract frequency information which may be utilized to determine whether the received wireless communications originated from device 12 or other appropriate source and to synchronize processing circuitry 24 with device 12 if appropriate. Other methods are possible for verifying a source of electromagnetic energy received within device 14 in other embodiments.

Referring to FIGS. 4A-4B, an exemplary circuit configuration of remote communications device 14 is shown. The depicted circuitry corresponds to the embodiment of FIG. 2 wherein monitoring circuitry 28 receives signals from a common receive antenna 32a also coupled with communications circuitry 30. In particular, the embodiment of FIG. 4A depicts a plurality of antennae 32a individually configured to one of receive RF energy including wireless communications 16 or output wireless communications 16. Communications circuitry 30 is embodied as an active transceiver circuit having part designation TB32301AFL available from Toshiba in the illustrated embodiment. In another embodiment, a transceiver embodied as a part number TRF6900A available from Texas Instruments or other device may be utilized. Processing circuitry 24 may be implemented using a processor 31 (e.g., MSP430F1121 available from Texas Instruments) as shown in FIG. 4B in one embodiment. For exemplary backscatter communications, processing circuitry 24 may implement selective reflection of RF energy using RX antenna 32a to output a wireless communications signal from device 14 in one embodiment. For example, an anode of diode 60 may be coupled with pin 8 (i.e., P2.0) of processor 31 instead of ground as shown for receiving control from processing circuitry 24 to implement backscatter communications.

In the illustrated configuration of FIG. 4B, the exemplary monitoring circuitry 28 is configured to pass signals having a frequency of 1-10 kHz corresponding to the frequency of wireless communications 16 received from communications device 12. Additional details regarding components and circuits of FIGS. 4A-4B are illustrated in Tables A-C below. Other arrangements or configurations are possible.

TABLE A

| PIN | LABEL |
|---|---|
| 1 | Vcc Syn3 |
| 2 | Vcc Syn2 |
| 3 | LOOP FIL1 |
| 4 | GND Syn2 |
| 5 | GND Syn3 |
| 6 | GND Syn1 |
| 7 | LD |
| 8 | REF CLK |
| 9 | Vcc Syn1 |
| 10 | DATA |
| 11 | CLK |
| 12 | STB |
| 13 | TXIN |
| 14 | BS |
| 15 | FLLC2 |
| 16 | Vcc RX3 |
| 17 | FLLC1 |
| 18 | RSSI |
| 19 | D-DATA |
| 20 | AF1 |
| 21 | Vcc RX2 |
| 22 | AF2 |
| 23 | GND RX3 |
| 24 | GND RX2 |
| 25 | IF-IN1 |
| 26 | IF-IN2 |
| 27 | GND RX1 |
| 28 | MIX OUT |
| 29 | MIX FL |
| 30 | Vcc RFRX |
| 31 | RF IN |
| 32 | GNDRF1 |
| 33 | GNDRF2 |
| 34 | TXOUT |
| 35 | Vcc RFTX |
| 36 | Vcc RF |

TABLE B

| LABEL | VALUE | | LABEL | VALUE | | LABEL | VALUE | |
|---|---|---|---|---|---|---|---|---|
| C 271 | 1000 | pF | C 361 | 1000 | pF | C 92 | 100 | pF |
| C 29A | 0.01 | μF | C 362 | 10 | pF | C 15A | 0.01 | μF |
| C 302 | 1000 | pF | C 11 | 10 | pF | C 161 | 0.01 | μF |
| C 301 | 10 | pF | C 12 | 100 | pF | C 162 | 1 | μF |
| C 311 | 22 | pF | C 21 | 10 | pF | C 171 | 0.01 | μF |
| C 343 | 1000 | pF | C 22 | 100 | pF | C 181 | 1000 | pF |
| C 341 | 10 | pF | C 31 | 4.3 | nF | C 201 | 0.1 | μF |
| C 342 | 10 | pF | C 32 | 10 | nF | C 202 | 300 | pF |
| C 352 | 1000 | pF | C 81 | 100 | pF | C 211 | 1000 | pF |
| C 351 | 10 | pF | C 91 | 10 | pF | C 212 | 0.1 | μF |

TABLE C

| LABEL | VALUE | |
|---|---|---|
| R31 | 2.7k | Ω |
| R71 | 10k | Ω |
| R77 | 10k | Ω |
| R101 | 100k | Ω |
| R191 | 10k | Ω |
| R201 | 1k | Ω |
| R281 | 200k | Ω |

Referring to FIGS. 5A-5B, another exemplary circuit configuration of remote communications device 14 is shown. The depicted circuitry corresponds to the embodiment of FIG. 2 wherein plural antennae 32b are individually coupled with a respective one of monitoring circuitry 28 and communications circuitry 30 (e.g., the antenna 32b coupled with monitoring circuitry 28 may receive RF energy and the antenna 32b coupled with communications circuitry 30 may transmit, reflect, and/or receive RF energy in the described embodiment). Details of components and circuits provided in Tables A-C also apply to the respective components and circuits of FIGS. 5A-5B in one embodiment. Other arrangements or configurations are possible.

Some aspects of the disclosure provide a low power wakeup mechanism for remote communications devices including active RFID tags in one embodiment. For active tags, receiver circuitry may account for a significant portion of power consumption of the device because the device may spend additional time listening for messages compared with transmission operations. At least some aspects herein enable the use of devices with smaller capacity batteries and/or extend the useful life of batteries of the devices. Accordingly, exemplary configurations herein provide battery powered remote communications devices which may be smaller, less expensive, and/or have longer useful lives.

According to exemplary arrangements discussed herein, the first receiver circuitry 20 draws about 4 μA of electrical energy compared with 26 mA of the above-mentioned TRF6900A transceiver. In a deep powered down mode of operation (e.g., during the absence of wireless communications 16), processing circuitry 24 described above may only consume 1 μA of electrical energy. Further, since first receiver circuitry 20 continually monitors for the presence of electromagnetic energy in at least one embodiment, response times of device 14 may be less than other devices. It is believed that at least some aspects described herein may provide significant reduction in power dissipation of remote communications devices 14 for moderate signal to noise environments. It is expected that at least applications in inventory control and sensor monitoring utilizing the above-described aspects may benefit significantly from the advantages described herein.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A wireless communications system comprising:
a reader configured to output a plurality of wireless communications signals;
a plurality of remote communications devices in communication with the reader and configured to receive the wireless communications signals; and
wherein at least one of the remote communications devices comprises communications circuitry configured to receive the wireless communications signals and processing circuitry configured to process the wireless communications signals, wherein the communications circuitry and the processing circuitry are individually configured to operate in a plurality of operational states including:
a first operational state corresponding to an absence of the wireless communications signals at the at least one remote communications device;
a second operational state corresponding to the presence of the wireless communications signals at the at least one remote communications device; and
wherein electrical energy is consumed at an increased rate by the remote communications device during the operation in the second operational state compared with the operation in the first operational state.

2. The system of claim 1 wherein the processing circuitry is configured to process data of the wireless communications signals and to implement an operation of the at least one remote communications device responsive to the processing of the data.

3. The system of claim 2 wherein the processing circuitry is configured to control the at least one remote communications device to implement the operation comprising outputting a wireless communications signal configured to identify the at least one remote communications device to implement radio frequency identification device (RFID) communications.

4. The system of claim 1 wherein the processing circuitry is configured to control selective reflection of radio frequency energy to output a wireless communications signal comprising a backscatter signal from the at least one of the remote communications devices.

5. The system of claim 1 wherein the at least one remote communications device comprises monitoring circuitry configured to monitor for the presence of the wireless communications signals at the at least one remote communications device.

6. The system of claim 5 wherein the processing circuitry and the communications circuitry are configured to enter the second operational state responsive to the monitoring by the monitoring circuitry detecting the presence of electromagnetic energy.

7. The system of claim 1 wherein the processing comprises verifying the wireless communications signals.

8. The system of claim 1 wherein the at least one of the remote communications devices comprises a plurality of the remote communications devices.

9. The system of claim 1 wherein the communications circuitry is configured to output wireless communications from the at least one remote communications device, and the at least one remote communications device further comprises a battery configured to provide electrical energy to the communications circuitry to enable the outputting of the wireless communications.

10. The system of claim 1 wherein the communications circuitry is configured to output wireless communications comprising identification information regarding the at least one remote communications device to implement radio frequency identification device (RFID) communications.

11. A remote communications device comprising:
communications circuitry configured to receive a plurality of wireless communications signals outputted by a reader;
processing circuitry coupled with the communications circuitry and configured to process the wireless communications signals and to implement at least one operation of the remote communications device responsive to the processing;
wherein the processing circuitry is operable in a plurality of operational states having different rates of consumption of electrical energy including a first operational state in the absence at the remote communications device of the wireless communications signals outputted by the reader and a second operational state corresponding to the presence at the remote communications device of the wireless communications signals outputted by the reader; and
wherein the rate of consumption of electrical energy by the communications circuitry is greater in the second operational state compared with the first operational state.

12. The device of claim 11 further comprising monitoring circuitry configured to monitor for the presence of the wireless communications signals and to indicate the presence of the wireless communications signals at the remote communications device responsive to the monitoring.

13. The device of claim 11 further comprising an antenna coupled with the monitoring circuitry and the communications circuitry.

14. The device of claim 11 further comprising plural antennae individually coupled with a respective one of the monitoring circuitry and the communications circuitry.

15. The device of claim 11 wherein the communications circuitry is operable in a plurality of operational states having different rates of consumption of electrical energy including a first operational state in the absence at the remote communications device of the wireless communications signals outputted by the reader and a second operational state corresponding to the presence at the remote communications device of the wireless communications signals outputted by the reader, wherein the rate of consumption of electrical energy by the communications circuitry is greater in the second operational state compared with the first operational state.

16. The device of claim 11 wherein the processing circuitry is configured to implement the operation comprising controlling the outputting of a backscattered signal from the remote communications device.

17. The device of claim 11 wherein the processing circuitry is configured to implement the operation comprising controlling an outputting of a wireless communications signal from the remote communications device.

18. The device of claim 17 further comprising a battery configured to provide operational electrical energy to the communications circuitry to enable the outputting of wireless communications signals from the remote communications device.

19. The device of claim 11 wherein the wireless communications signals outputted from the remote communications device comprise identification information regarding the remote communications device to implement radio frequency identification device (RFID) communications.

20. A remote communications device comprising:
first receiver means for monitoring for the presence of wireless communications signals outputted by a reader;
second receiver means for receiving the wireless communications signals outputted by the reader;
processing means for processing the wireless communications signals received by the second receiver means; and
wherein the second receiver means and the processing means comprise means for operating in a plurality of operational states having different rates of electrical energy consumption including a first operational state corresponding to an absence of the wireless communications signals at the remote communications device and a second operational state corresponding to the presence of the wireless communications signals at the remote communications device, wherein the second receiver means and the processing means individually have an increased rate of consumption of electrical energy during operations in the second operational state compared with the first operational state.

21. The device of claim 20 wherein the second receiver means comprises means for operating in the first operational state during less than an entirety of a time period corresponding to the absence of the wireless communications signals.

22. A wireless communications method comprising:
receiving a plurality of wireless communications signals outputted by a reader using a remote communications device;
controlling processing circuitry of the remote communications device to consume electrical energy at different rates corresponding to respective ones of a presence and an absence of the wireless communications signals at the remote communications device, wherein the processing circuitry is configured to control at least one operation of the remote communications device;
first consuming electrical energy using the processing circuitry at a first rate corresponding to the presence of the wireless communications signals at the remote communications device;
second consuming electrical energy using the processing circuitry at a second rate corresponding to the absence of the wireless communications signals at the remote communications device; and
wherein the first consuming at the first rate comprises consuming the electrical energy at an increased rate compared with the second consuming at the second rate.

23. The method of claim 22 further comprising controlling receiver circuitry configured to receive the wireless communications signals to consume electrical energy at the different rates.

24. The method of claim 23 wherein the controlling the receiver circuitry to operate at the increased rate comprises enabling the receiver circuitry to operably receive the wireless communications signals.

25. The method of claim 22 wherein the controlling comprises monitoring for the presence of the wireless communications signals using monitoring circuitry and controlling the processing circuitry to switch energy consumption from the first rate to the second rate responsive to detection of the wireless communications signals by the monitoring circuitry.

26. The method of claim 25 further comprising processing the wireless communications signals using the processing circuitry consuming electrical energy at the second rate.

27. The method of claim 25 further comprising controlling receiver circuitry to operate at an increased rate of electrical energy consumption responsive to the detection.

28. The method of claim 22 further comprising outputting the wireless communications signals using the reader.

29. The method of claim 22 further comprising outputting wireless communications signals using the remote communications device and comprising identification information regarding the remote communications device to implement radio frequency identification device (RFID) communications.

30. A wireless communications method comprising:
providing a remote communications device;
monitoring for the presence of wireless communications signals outputted by a reader using the remote communications device;
changing operations of processing circuitry and receiver circuitry of the remote communications device from a reduced electrical energy consumption rate to an increased electrical energy consumption rate responsive to the monitoring detecting the presence of the wireless communications signals from the reader;
operably receiving the wireless communications signals using the receiver circuitry operating at the increased electrical energy consumption rate; and
returning operations of the receiver circuitry from the increased electrical energy consumption rate to the reduced electrical energy consumption rate after the receiving.

31. The method of claim 30 further comprising:
providing the reader; and
outputting the wireless communications signals using the reader.

32. The method of claim 30 further comprising outputting wireless communications signals using the remote communications devices.

33. The method of claim 32 wherein the outputting comprises outputting using electrical energy provided by a battery of the remote communications device.

34. The method of claim 32 wherein the outputting comprises outputting identification information regarding the remote communications device to implement radio frequency identification device (RFID) communications.

35. The method of claim 30 wherein the monitoring comprises monitoring using monitoring circuitry and the monitoring circuitry and the receiver circuitry receive radio frequency energy from respective individual antennae.

36. The method of claim 30 wherein the changing comprises enabling the processing circuitry to process the wireless communications signals.

37. The method of claim 30 wherein the changing comprises enabling the receiver circuitry to operably receive the wireless communications signals.
